(19) United States
(12) Patent Application Publication
(10) Pub. No.: US 2020/0284716 A1
(43) Pub. Date: Sep. 10, 2020

(54) VIBRATION IMAGING USING EXTERNAL REFERENCE SIGNAL

(71) Applicant: SRI International, Menlo Park, CA (US)

(72) Inventor: Gregory Tibor Alexander Kovacs, Palo Alto, CA (US)

(21) Appl. No.: 16/292,059

(22) Filed: Mar. 4, 2019

(51) Int. Cl. G01N 21/01; G01N 21/3577; G01N 21/62; G01N 21/55

(52) U.S. Cl. CPC G01N 21/01; G01N 21/55; G01N 21/62; G01N 21/3577

(57) ABSTRACT

Techniques are disclosed for detecting a vibration of a target object using light signals and an external reference signal. In one example, a sensor detects a first signal having a first plurality of frequencies. An array of light amplitude detectors receives respective light signals from regions of the target object and generates outputs representing the received light signals. A plurality of filters receives an output of a respective light amplitude detector and generates, from the output and based on the first plurality of frequencies, filtered signals. The filtered signals relate to a vibration of the target object, and a frequency of the vibration of the region of the target object is within a frequency band defined by at least one frequency of the first plurality of frequencies. Processing circuitry processes the filtered signals to generate an output representation of the vibration of the target object.

### TECHNICAL FIELD

This disclosure generally relates to rendering images of vibration.

### BACKGROUND

Vibration imaging spectroscopy (VIS) is a technique for visualizing a vibration of a target object. VIS is conventionally implemented using digital processing (e.g., Fast Fourier Transform) performed using a luminance of each pixel of an image acquired via a digital video camera. Digital VIS systems, given significant computer power, can provide real-time processing of vibration spectra of all pixels in the image up to the Nyquist rate (e.g., ½ of the frame rate of the digital video camera). However, digital VIS systems require expensive, bulky, and power-intensive (high Size, Weight and Power, or SWAP) digital computational hardware. Thus, digital VIS systems are prohibitive to use in cost and SWAP-sensitive applications.

### SUMMARY

In general, the disclosure describes techniques for detecting a vibration of a target object using light signals and an external reference signal. A VIS system is based on the phenomenon in which a vibrating surface of a target object modulates reflected light at a frequency corresponding to a frequency of the vibrating surface. The VIS system may detect and process the modulation of the reflected light to identify a frequency of the vibration in the target object. Using the techniques described herein, a VIS system may use a reference signal to “tune” the VIS system to a specific frequency corresponding to the reference signal such that the VIS system may be used to hunt or seek for vibrations occurring at particular frequencies of interest.

A VIS system as described herein integrates analog signal processing into each individual pixel element of an optical array for the VIS system. For example, each pixel element of an optical array of the VIS system may perform analog signal processing on a received light signal reflected from a target object so as to extract amplitude information from the received light signal. The VIS system may use the extracted amplitude information to construct an image showing intensity, duration, and location of vibrations in both time series and frequency spectra of the target object. By performing such analog signal processing within the optical array, a VIS system as described herein may obviate the need for an external computing system to perform computationally-expensive processing on the received light signals.

In some examples, each pixel element may mix (e.g., multiply or perform heterodyning on) an electrical signal representing the received light signal with a reference signal so as to extract amplitude information from the received light signal at a frequency or frequencies corresponding to a frequency of the reference signal. In some examples, the reference signal may be generated by a physical sensor, such as an audio signal generated by microphone or an electrical signal generated by an accelerometer or electromagnetic sensor, that is indicative of an acoustic vibration, physical or mechanical vibration, or an electromagnetic signal in an environment that correlates to a vibration in the target object. The use of such a reference signal may allow a VIS system as described herein to quickly isolate and detect vibration sources at frequencies of interest to a user.

The techniques of the disclosure may provide specific technical improvements. For example, the techniques of the disclosure may reduce the SWAP of VIS systems. Further, in contrast to a conventional, digital VIS system, the analog VIS system as described herein may have increased frequency range beyond a frame rate of the VIS system through the use of a direct analog multiplication or heterodyne architecture. Further, the techniques of the disclosure may allow for the development of low-cost industrial cameras and medical VIS cameras. The reduction in SWAP of VIS system set forth herein may allow for the integration of VIS system in autonomous vehicles, drones, mobile devices, medical devices, hand-held thermal imagers, and automobiles. Additionally, the use of a reference signal may allow the VIS system or a user to identify vibration at frequencies of interest, thereby allowing a user to more rapidly isolate and acquire a target object as a source of vibration.

In one example, this disclosure describes a system for detecting a vibration of a target object using light signals, the system comprising: a sensor configured to generate an output of the sensor, the output of the sensor indicative of a first signal detected by the sensor, wherein the first signal has a first plurality of frequencies; an array of light amplitude detectors, wherein each respective light amplitude detector in the array of light amplitude detectors is configured to receive a respective light signal from a region of the target object that corresponds to the respective light amplitude detector and to generate an output of the respective light amplitude detector, the output of the respective light amplitude detector representing the light signal received by the respective light amplitude detector from the region of the target object that corresponds to the respective light amplitude detector, wherein the sensor is external to the array of light amplitude detectors; a plurality of filters, wherein each filter of the plurality of filters is operatively coupled to a respective light amplitude detector of the array of light amplitude detectors and each filter of the plurality of filters is operatively coupled to the sensor, and wherein each respective filter of the plurality of filters is configured to: receive, from the light amplitude detector of the array of light amplitude detectors operatively coupled to the respective filter, the output of the respective light amplitude detector; and generate, from the output of the respective light amplitude detector and based on the first plurality of frequencies of the first signal, a filtered signal of the respective filter, wherein the filtered signal of the respective filter relates to a vibration of the region of the target object that corresponds to the respective light amplitude detector, and wherein a frequency of the vibration of the region of the target object that corresponds to the respective light amplitude detector is within a frequency band defined by at least one frequency of the first plurality of frequencies; and processing circuitry configured to process the filtered signals of the plurality of filters to generate an output representation of the vibration of the target object.

In another example, this disclosure describes a method for detecting a vibration of a target object using light signals, the method comprising: generating, by a sensor, an output of the sensor, the output of the sensor indicative of a first signal detected by the sensor, wherein the first signal has a first plurality of frequencies; generating, by each respective light amplitude detector in an array of light amplitude detectors, an output of the light amplitude detector, the output of the respective light amplitude detector representing a light signal received by the respective light amplitude detector from a region of the target object that corresponds to the respective light amplitude detector, wherein the sensor is external to the array of light amplitude detectors; receiving, by each respective filter of a plurality of filters and from a respective light amplitude detector of the array of light amplitude detectors operatively coupled to the respective filter, the output of the respective light amplitude detector; and generating, by each respective filter of the plurality of filters, from the output of the respective light amplitude detector, and based on the first plurality of frequencies of the first signal, a filtered signal of the respective filter, wherein the filtered signal of the respective filter relates to a vibration of the region of the target object that corresponds to the respective light amplitude detector, wherein a frequency of the vibration of the region of the target object that corresponds to the respective light amplitude detector is within a frequency band defined by at least one frequency of the first plurality of frequencies; and processing, by processing circuitry, the filtered signals of the plurality of filters to generate an output representation of the vibration of the target object.

In another example, this disclosure describes a device for detecting a vibration of a target object using light signals, the device comprising: a sensor configured to generate an output of the sensor, the output of the sensor indicative of a first signal detected by the sensor, wherein the first signal has a first plurality of frequencies; an array of light amplitude detectors, wherein each respective light amplitude detector in the array of light amplitude detectors is configured to receive a respective light signal from a region of the target object that corresponds to the respective light amplitude detector and to generate an output of the respective light amplitude detector, the output of the respective light amplitude detector representing the light signal received by the respective light amplitude detector from the region of the target object that corresponds to the respective light amplitude detector, wherein the sensor is external to the array of light amplitude detectors; a plurality of filters, wherein each filter of the plurality of filters is operatively coupled to a respective light amplitude detector of the array of light amplitude detectors and each filter of the plurality of filters is operatively coupled to the sensor, and wherein each respective filter of the plurality of filters is configured to: receive, from the light amplitude detector of the array of light amplitude detectors operatively coupled to the respective filter, the output of the respective light amplitude detector; and generate, from the output of the respective light amplitude detector and based on the first plurality of frequencies of the first signal, a filtered signal of the respective filter, wherein the filtered signal of the respective filter relates to a vibration of the region of the target object that corresponds to the respective light amplitude detector, and wherein a frequency of the vibration of the region of the target object that corresponds to the respective light amplitude detector is within a frequency band defined by at least one frequency of the first plurality of frequencies; and processing circuitry configured to process the filtered signals of the plurality of filters to generate an output representation of the vibration of the target object.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example vibration imaging spectroscopy (VIS) system for detecting vibration of a target object using light signals in accordance with the techniques of the disclosure.

FIG. 2 is a block diagram illustrating an example pixel element of the VIS system of FIG. 1 in accordance with the techniques of the disclosure.

FIG. 3 is a circuit diagram illustrating an example pixel element in accordance with the techniques of the disclosure.

FIG. 4 is a circuit diagram illustrating an example pixel element in accordance with the techniques of the disclosure.

FIG. 5 is an illustration depicting an example output representation of vibration amplitude of a target object in accordance with the techniques of the disclosure.

FIG. 6 is a flowchart illustrating an example operation for detecting vibration of a target object using light signals in accordance with the techniques of the disclosure.

Like reference characters refer to like elements throughout the figures and description.

### DETAILED DESCRIPTION

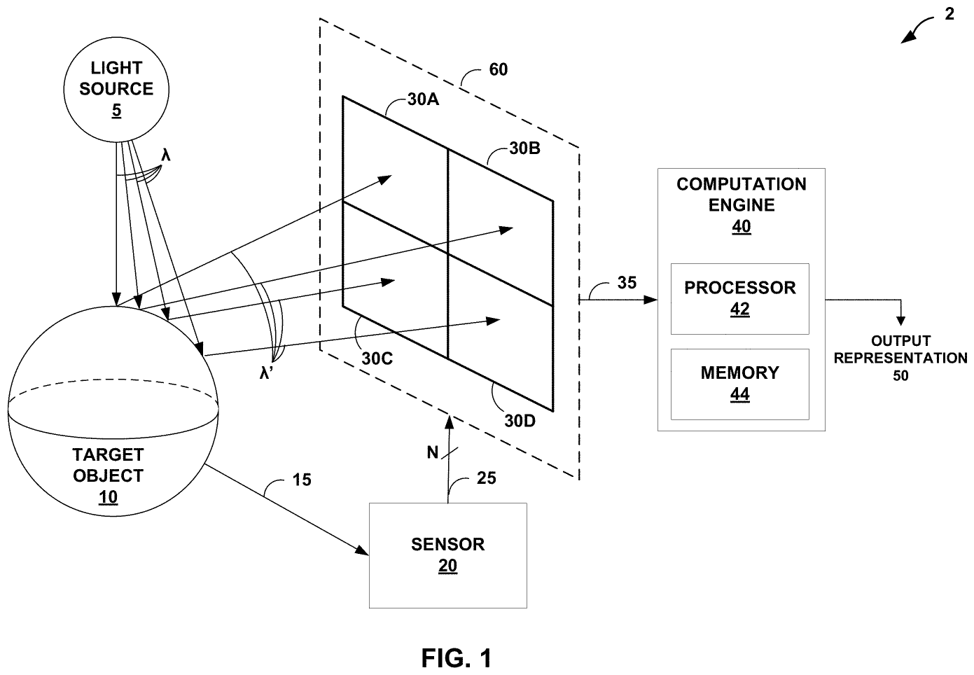

FIG. 1 is a block diagram illustrating an example VIS system 2 for detecting vibration of target object 10 using light signals in accordance with the techniques of the disclosure. VIS system 2 includes optical array 60 that comprises a plurality of pixel elements 30A-30D (hereinafter, “pixel elements 30”), sensor 20, and computation engine 40. VIS system 2 processes light (λ) from light source 5 that is reflected from target object 10 to generate output representation 50 of a vibration in target object 10.

Light source 5 may be any form of light source. Examples of light source 5 include natural light from the sun or light from artificial sources, such as light from fluorescent, incandescent, or halogen bulbs, light-emitting diodes (LEDs), etc. Light source 5 may emit light λ in various different spectra, such as in the form of visible light, ultraviolet light, infrared light, etc.

Target object 10 may be any object. For example, target object 10 may be a mechanical device such as a motor or vehicle. Target object 10 may also be a person, an animal, a plant or tree, or an inanimate object such as a rock or building. In the example of FIG. 1, vibrates at a particular frequency. The vibration of target object 10 modulates light λ as reflected light λ′ having a luma (brightness) component that oscillates at a frequency corresponding to the frequency of the vibration of target object 10.

VIS system 2 detects and processes reflected light λ′ to identify one or more frequencies of the vibration in target object 10 and generate output representation 50 of the vibration in target object 10. For example, each pixel element 30 detects reflected light λ′ reflected from a respective region of target object 10 and generates an electrical signal representative of a luma component of the reflected light λ′. Each pixel element 30 performs analog signal processing on the electrical signal representative of the luma component of the reflected light λ′, such as multiplication and filtering, so as to generate filtered signals 35 from reflected light λ′. In some examples, each pixel element 30 is an analog multiplication circuit, such as a Gilbert cell. In the example of FIG. 1, optical array 60 includes 4 pixel elements 30A, 30B, 30C, and 30D in a 1:1 aspect ratio. However, this illustration is provided for ease of explanation only, and in other examples, optical array 60 may include any number of pixel elements 30 and/or various different aspect ratios.

Sensor 20 is physical sensor that generates reference signal 25 indicative of an acoustic or physical vibration 15 in an environment. Typically, the acoustic or physical vibration 15 comprises a frequency or plurality of frequencies of interest to a user. Vibration 15 may comprise one or multiple harmonically related frequencies (e.g., a Fourier series) that correlate to the vibration in target object 10. For example, where target object 10 is a motor, vibration 15 may be an audible noise that correlates to an unusual vibration in target object 10. In some examples, sensor 20 is a microphone, accelerometer, electromagnetic sensor, or pressure sensor. In another example, sensor 20 senses an electrocardiogram (ECG) or photoplethysmogram of a patient.

Sensor 20 provides reference signal 25 to each of pixel elements 30 indicative of the sensed vibration 15 in the environment. In some examples, reference signal 25 is an audio signal indicative of an audible vibration in the environment or an electromagnetic signal indicative of a physical or mechanical vibration or an electromagnetic signal in the environment. Each pixel element 30 may multiply (e.g., mix) a respective electrical signal representing a luma component of reflected light λ′ with reference signal 25 and apply low-pass filtering to the resulting product so as to generate a respective filtered signal 35. Each respective filtered signal 35 has a DC component (where a modulation frequency of the luma component of reflected light λ′ due to vibration in target object 10 is the same as a frequency of reference signal 25) or a low frequency component permitted by the low-pass filter (where a modulation frequency of the luma component of reflected light λ′ due to vibration in target object 10 is similar to but not the same as the frequency of reference signal 25). Further, each respective filtered signal 35 has an amplitude corresponding to an amplitude of vibration of target object 10 at the frequency of reference signal 25. The use of such a reference signal may allow a VIS system as described herein to quickly isolate and detect vibration sources at frequencies of interest to a user (e.g., an audio signal occurring at audible frequencies heard by a user and detected via a microphone, or a mechanical vibration occurring at frequencies perceived by the user and detected via an accelerometer).

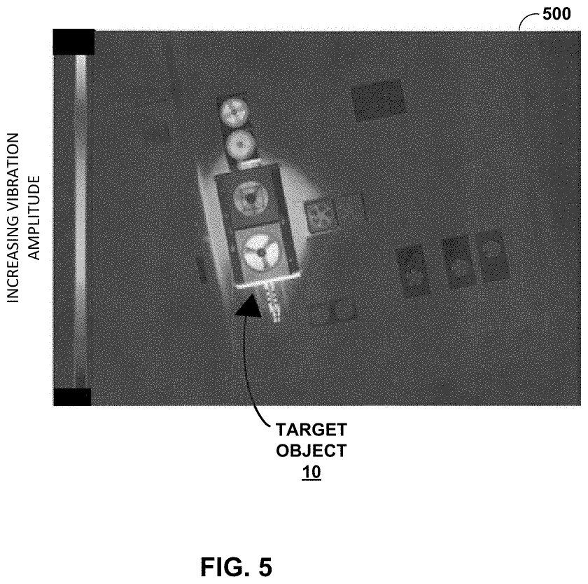

Computation engine 40 processes filtered signals 35 to generate output representation 50 of a vibration in target object 10. Output representation 50 may be, e.g., an image showing intensity, duration, and location of vibrations in both time series and/or frequency spectra of the target object. For example, as discussed in more detail below with respect to FIG. 5, an amplitude of filtered signals 35 may correspond to an amplitude of modulation of the luma component of reflected light λ′ received via one of pixel elements 30, which in turn corresponds to an amplitude of vibration of target object 10 at one or more frequencies of reference signal 25. Therefore, it may be recognized that output representation 50 may be a representation of vibration amplitude in target object 10 at a frequency corresponding to a frequency detected by sensor 20 or approximating the frequency detected by sensor 20.

In some examples, computation engine 40 creates an output image representing a vibration in target object 10. The output image may comprise an array of pixels. A characteristic of each pixel of the array of pixels of the output image may be associated with an amplitude of a filtered signal 35 received from a respective pixel element of pixel elements 30. Thus, the characteristic of each pixel of the array of pixels may be associated with the amplitude of vibration of the corresponding region of the target object. The characteristic of each pixel may be, e.g., a luma component (e.g., brightness), a chroma component (e.g., color), or a combination thereof. Thus, as one example, a value of the luma component of pixel of the array of pixels may be associated with the amplitude of the vibration of the corresponding region of the target object. As another example, a color of the pixel may be associated with the amplitude of the vibration of the corresponding region of the target object.

In some examples, computation engine 40 assigns different colors to different amplitude thresholds. For example, a color of a pixel in the output image may correspond to an intensity of vibration at a surface of target object 10. As another example, a color of a pixel in the output image may correspond to a frequency of the vibration at a surface of target object 10. As another example, a color of a pixel in the output image may correspond to a difference (e.g., a delta) between a frequency of the vibration at a surface of target object 10 and at least one frequency of reference signal 25. In some examples, computation engine 40 assigns a unique color (e.g., chroma) to each pixel exhibiting vibration at a frequency corresponding to the at least one frequency of reference signal 25 and assigns a luma component to each pixel according to an amplitude of the detected vibration. Therefore, it may be recognized that the output image may be used to rapidly visualize and identify the source of a vibration at a frequency corresponding to a frequency detected by sensor 20 within an environment.

In the example of FIG. 1, each pixel element 30 detects a luma component of reflected light multiplies an electrical signal representing the luma component of reflected light λ′ with reference signal 25, and filters the product to generate filtered signal 35. However, in other examples, instead of multiplying the electrical signal representing the luma component of reflected light λ′ with reference signal 25, each pixel element 30 instead multiplies the electrical signal representing the luma component of reflected light λ′ with an output of a global local oscillator (not depicted in FIG. 1). The global local oscillator may be configured to generate an output that sweeps across a particular band of frequencies. The use of such a local oscillator may allow pixel element 30 to generate a time-variant filtered signal, the amplitude of which is indicative of vibration in target object 10 at a particular frequency. Computation engine 40 may use such a time-variant filtered signal to produce a composite image of vibration in target object 10 across the band of frequencies (e.g., an analog spectrum analyzer). For example, computation engine 40 may assign different colors (e.g., or values of chroma) to different frequencies so as to produce an output image in which a color of each pixel in the output image corresponds to the presence of vibration in target object 10 at a particular frequency within the band of frequencies. For example, computation engine 40 may assign the color blue to no vibration, yellow to vibration at mid-frequencies, red to vibration at high-frequencies, and encode the amplitude of vibration as luma.

Computation engine 40 includes processor 42 and memory 44. In some examples, processor 42 is one or more microprocessors, digital signal processors (DSPs), application specific integrated circuits (ASICs), field programmable gate arrays (FPGAs), or any other equivalent integrated or discrete logic circuitry, as well as any combinations of such components. In some examples, memory 44 is random access memory (RAM), read only memory (ROM), programmable read only memory (PROM), erasable programmable read only memory (EPROM), electronically erasable programmable read only memory (EEPROM), flash memory, comprising executable instructions for causing the one or more processors to perform the actions attributed to them. Further, computation engine 40 may be implemented entirely in hardware, software, or a combination thereof.

The techniques of the disclosure may provide specific technical improvements. For example, the techniques of the disclosure may reduce the SWAP of VIS systems. Further, in contrast to a conventional, digital VIS system, the analog VIS system as described herein may have increased frequency range because the use of a direct analog multiplication or heterodyne architecture allows the frequency of multiplication to be independent from the frame rate of the VIS system. Further, the techniques of the disclosure may allow for the development of low-cost industrial cameras and medical VIS cameras. The reduction in SWAP of a VIS system set forth herein may allow for the integration of VIS system 2 in autonomous vehicles, drones, mobile devices, medical devices, hand-held thermal imagers, and automobiles. Additionally, the use of a reference signal may allow VIS system 2 or a user to identify vibration at frequencies of interest, thereby allowing a user to more rapidly isolate and acquire a target object as a source of vibration.

VIS system 2, as described herein, may be of practical use in many different applications. For example, unexpected, unusual, or pronounced vibrations may be symptomatic of technical problems in numerous types of mechanical devices, such as aircraft engines, power transformers, or other machinery. VIS system 2, as described herein, may reduce the cost of maintenance in such mechanical devices by allowing for rapid and cost-effective identification of the source of such vibrations. Furthermore, the detection and isolation of sources of vibration in an environment may be of use for government, military, law enforcement, or environmental applications. For example, VIS system 2, as described herein, may be able to identify vibration in foliage that reveals the presence of obscured machinery or vehicles. Additionally, VIS system 2 as described herein may be used for non-invasive imaging of the human body for a variety of medical applications. For example, where sensor 20 senses an ECG (e.g., a heartbeat or other pulsing tissue) of a patient, VIS system 2 may be used to phase-lock onto the ECG, allowing a clinician to visualize blood flow through a body of the patient. As further examples, VIS system 2, as described herein, may be used to identify vibration occurring at frequencies greater than audible frequencies (e.g., ultrasonic vibrations).

Furthermore, VIS system 2 may be used in conjunction with other conventional imaging techniques. For example, output representation 50 may be simultaneously overlaid upon another type of image, such as an image of one or more of visible-light, thermal, infrared, ultraviolet, or another wavelength. As another example, output representation 50 may be simultaneously overlaid upon a medical image of a patient, such as an x-ray image or a magnetic resonance imaging (MRI) image. The resulting composite image may be more useful and provide increased visual information to a user over conventional imaging techniques alone.

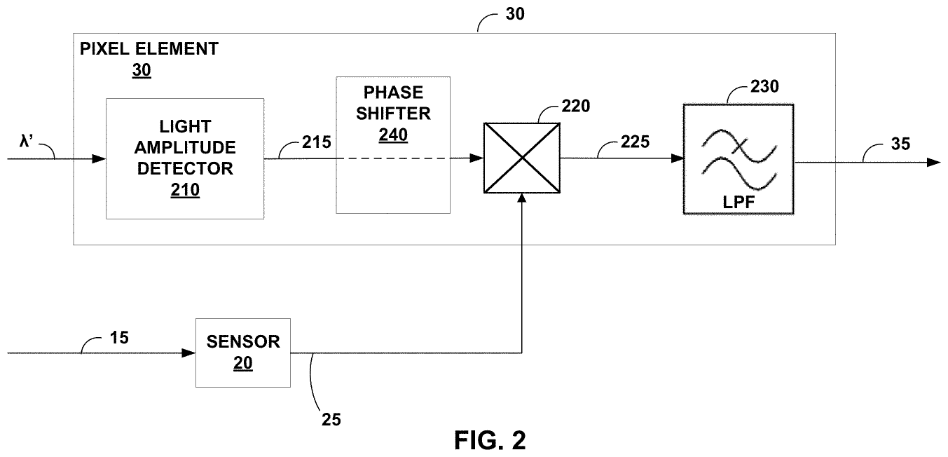

FIG. 2 is a block diagram illustrating example pixel element 30 of VIS system 2 of FIG. 1 in accordance with the techniques of the disclosure. Pixel element 30 is an analog circuit that processes light λ′ reflected from target object 10 of FIG. 1 to generate filtered signal 35. In some examples, pixel element 30 is an analog multiplication circuit, such as a Gilbert cell. An intensity of filtered signal 35 corresponds to the presence of vibration in target object 10 at a frequency corresponding to at least one frequency of reference signal 25. Pixel element 30 includes light amplitude detector 210, analog multiplier 220, and low-pass filter 230.

Light amplitude detector 210 receives reflected light λ′ and outputs electrical signal 215 indicative of a luma component of reflected light λ′. In some examples, instead of a luma component, electrical signal 215 is indicative of a brightness, intensity, or luminance of reflected light λ′. In some examples, light amplitude detector 210 is an analog light amplitude detector, such as an analog photodetector or photosensor, such as a photodiode, photoresistor, or photoconductor, that generates an analog output representing reflected light λ′ received by the analog light amplitude detector from the region of target object 10 that corresponds to the analog light amplitude detector.

Sensor 20 is a physical sensor that generates reference signal 25 indicative of an acoustic or physical vibration or electromagnetic signal 15 in an environment. Typically, the acoustic or physical vibration 15 comprises a frequency of interest to a user. Vibration 15 may comprise one or multiple harmonically-related frequencies (e.g., a Fourier series) that correlate to the vibration in target object 10. For example, where target object 10 is a motor, vibration 15 may be an audible noise that correlates to an unusual vibration in target object 10. In some examples, sensor 20 is a microphone, accelerometer, electromagnetic sensor, or pressure sensor. In another example, sensor 20 senses an electrocardiogram (ECG) or photoplethysmogram of a patient.

Analog multiplier 220 is an example of an analog mixer circuit. Analog multiplier 220 is operatively coupled to light amplitude detector 210 and to sensor 20. Analog multiplier 220 receives electrical signal 215 indicative of the luma component of reflected light λ′ and reference signal 25 and multiplies the two signals together to generate output signal 225. In some examples, analog multiplier 220 is a DC-coupled, one-quadrant multiplier. In some examples, analog multiplier 220 is a heterodyning circuit and output signal 225 is the heterodyne of electrical signal 215 and reference signal 25. The output of analog multiplier 220 may be defined by the below equation, where h_{x,y} is a vibration amplitude of a particular pixel (x,y), A is a frequency of electrical signal 215, and B is a frequency of reference signal 25:

$${h}_{x , y} * sin ( A ) sin ( B ) = \frac{{h}_{x , y}}{2} cos ( A - B ) * \frac{- {h}_{x , y}}{2} cos ( A + B )$$

Where the frequency f of electrical signal 215 is equal to the frequency of reference signal 25 (A=B), the output of analog multiplier 220 may be defined as follows:

$${h}_{x , y} * sin ( A ) sin ( B ) = \frac{{h}_{x , y}}{2} - \frac{{h}_{x , y}}{2} cos ( 2 A ) ,$$

with

$$\frac{{h}_{x , y}}{2}$$

being the DC component and

$$\frac{{h}_{x , y}}{2}$$

cos(2A) producing a 2f term.
While in the example of FIG. 2, pixel element 30 includes analog multiplier 220, in other examples, other types of analog mixers may instead be used, such as an analog multiplier, analog modulator, or analog divider, to mix the output of a respective light amplitude detector 210 with reference signal 25.

In some examples where sensor 20 includes time delay, phase shifter 240 may be interposed between light amplitude detector 210 and analog multiplier 220. For example, where sensor 20 is an acoustic sensor that senses audible sound, reference signal 25 may propagate more slowly than electrical signal 215 because the sound sensed by sensor 20 propagates more slowly than reflected light λ′ sensed by light amplitude detector 210. The use of phase shifter 240 may allow one to optimize the multiplication of electrical signal 215 and reference signal 25 in such situations by delaying electrical signal 215.

Low-pass filter 230 is operatively coupled to analog multiplier 220, and operatively coupled to light amplitude detector 210 via analog multiplier 220. Low-pass filter 230 filters output signal 225 to generate filtered signal 35. An amplitude of filtered signal 35 corresponds to the presence of vibration in target object 10 at a frequency corresponding to at least one frequency of reference signal 25. For example, the amplitude of filtered signal 35 may have a high value where target object 10 is undergoing vibration at a frequency that is the same or about the same as the at least one frequency of reference signal 25. As another example, the amplitude of filtered signal 35 may have a low value where target object 10 is not vibrating or is undergoing vibration at a frequency that is the different from the at least one frequency of reference signal 25.

The spectral component of filtered signal 35 may change as a difference between a frequency of the vibration in target object 10 and the frequency of reference signal 25 changes. For example, filtered signal 35 has a DC component where a modulation frequency of the luma component of reflected light λ′ due to vibration in target object 10 is the same as a frequency of reference signal 25. Further, filtered signal 35 has a low frequency component where a modulation frequency of the luma component of reflected light λ′ due to vibration in target object 10 is similar to but not the same as a frequency of reference signal 25. The maximum frequency component of filtered signal 35 is defined by low-pass filter 230, which functions to limit the maximum difference between a frequency of vibration in target object 10 and the frequency (or frequencies) of reference signal 25.

The characteristics of low-pass filter 230 may be selected by a designer to allow for a particular granularity with respect to a frequency of vibration in target object 10 and the frequency (or frequencies) of reference signal 25. For example, the frequency bandwidth of vibrations in target object 10 which may be deemed as “the same or about the same” as a desired frequency of reference signal 25 may be adjusted by adjusting the passband of low-pass filter 230. For example, low-pass filter 230 may be configured to pass DC values only (e.g., where the frequency f of electrical signal 215 is equal to the at least one frequency of reference signal 25). In other examples, low-pass filter 230 is configured to pass and rectify (e.g., via a diode detector) all frequencies (e.g., passing both DC values and 2f frequencies), such as the scenario where the frequency f of electrical signal 215 is not equal to the at least one frequency of reference signal 25. While in the example of FIG. 2, filter 230 is a low-pass filter, in other examples, pixel element 30 may instead use a band-pass filter instead of a low-pass filter. Such a band-pass filter may be an adjustable band-pass filter that is centered on the at least one frequency of reference signal 25. The use of a band-pass filter may enable searching for vibrations in target 10 having frequencies that are related to, but not the same as, a frequency of reference signal 25, such as may be the case for harmonic vibrations or in the presence of vibrational nonlinearities.

Thus, the use of reference signal 25 may allow pixel element 30 to phase-lock on to vibration sources occurring at frequencies of interest to a user (e.g., at audible frequencies heard by a user and detected via a microphone, or at frequencies perceived by the user and detected via an accelerometer), as well as simultaneously occurring harmonics to those frequencies of interest. Thus, pixel element 30 may quickly capture vibration at or about the frequencies of interest, while excluding noise due to vibration at unwanted frequencies.

In the example of FIG. 2, analog multiplier 220 multiplies electrical signal 215 with reference signal 25. However, in other examples, analog multiplier 220 instead multiplies electrical signal 215 with an output of a local oscillator (not depicted in FIG. 2). The local oscillator may be configured to generate an output that sweeps across a particular band of frequencies. The use of such a local oscillator may allow pixel element 30 to generate a time-variant filtered signal, the amplitude of which is indicative of vibration in target object 10 at a particular frequency. Computation engine 40 of FIG. 1 may use such a time-variant filtered signal to produce a composite image of vibration in target object 10 across the band of frequencies as described above. Alternatively, instead of a local oscillator, pixel element 30 may apply a time-variant DC gain to analog multiplier 220 to achieve the same effect.

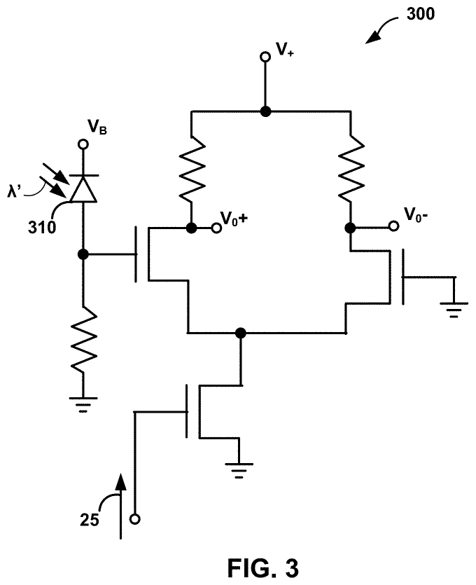

FIG. 3 is a circuit diagram illustrating an example pixel element 300 in accordance with the techniques of the disclosure. Pixel element 300 may be, for example, any of pixel elements 30 of FIG. 1 or pixel element 30 of FIG. 2. Pixel element 300 is an analog circuit that processes light λ′ reflected from target object 10 of FIG. 1 to generate a filtered signal. An amplitude of the filtered signal corresponds to the presence of vibration in target object 10 at a frequency corresponding to at least one frequency of reference signal 25. Pixel element 300 includes photodiode 310, which may be an example of light amplitude detector 210 of FIG. 2.

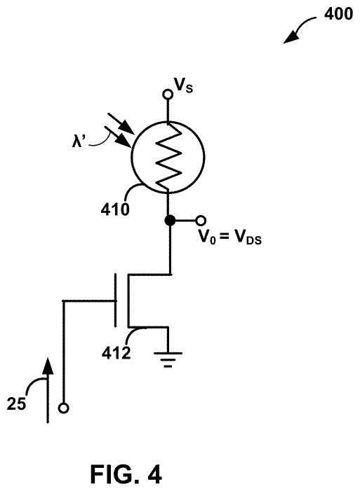

FIG. 4 is a circuit diagram illustrating an example pixel element 400 in accordance with the techniques of the disclosure. Pixel element 400 may be, for example, any of pixel elements 30 of FIG. 1 or pixel element 30 of FIG. 2. Pixel element 400 may be, for example, any of pixel elements 30 of FIG. 1 or pixel element 30 of FIG. 2. Pixel element 400 is an analog circuit that processes light λ′ reflected from target object 10 of FIG. 1 to generate a filtered signal V_{DS}. For example, a voltage amplitude of filtered signal V_{DS} corresponds to the presence of vibration in target object 10 at a frequency corresponding to at least one frequency of reference signal 25. Pixel element 400 includes photoresistor 410, which may be an example of light amplitude detector 210 of FIG. 2.

The behavior of transistor 412 may be described according to the following equations:

$${R}_{DS} = \frac{L}{{μ}_{n} {C}_{OX} W [ {V}_{GS} - {V}_{TH} - \frac{{V}_{DS}}{2} ]}$$

$${I}_{D} = {μ}_{n} {C}_{OX} \frac{W}{L} [ ( {V}_{GS} - {V}_{TH} ) {V}_{DS} - \frac{{V}_{DS}^{2}}{2} ]$$

where R_{DS} is the resistance between the drain and source of transistor 412,

$$\frac{L}{W}$$

is the ratio of length to width of transistor 412, μₙC_{OX} is the process transconductance parameter of transistor 412, V_{GS} is the voltage between the gate and drain of transistor 412, V_{TH} is the threshold voltage of transistor 412, and V_{DS} is the voltage between the drain and source of transistor 412, and I_{D} is the drain current of transistor 412.

Transistor 412 is selected so as to have a suitable cross term, as obtained via the following equations:

$${V}_{DS} = {V}_{S} \frac{{R}_{DS}}{{R}_{DS} + {R}_{D} ( {λ}^{′} ) \\ k = {μ}_{n} {C}_{OX} \frac{W}{L}}$$

where V_{S} is the supply voltage and R_{DS} is the drain resistance of transistor 412. The cross term may be obtained as follows:

$${V}_{DS} = \frac{1}{1 + {R}_{D} ( {λ}^{′} ) ( k ) ( {V}_{GS} - {V}_{TH} - \frac{{V}_{DS}}{2} )}$$

such that k*R_{D}(λ′)*V_{GS} is the cross term.

FIG. 5 is an illustration depicting example output representation 500 of vibration amplitude of target object 10 in accordance with the techniques of the disclosure. For convenience, FIG. 5 is described with respect to FIG. 1. Output representation 500 is an image showing intensity and location of vibrations of target object 10. As described above, computation engine 40 processes filtered signals 35 to generate output representation 500 of a vibration in target object 10. Each pixel of output representation 500 corresponds to a filtered signal 35 output by a respective pixel element 30. Further, each filtered signal 35 is indicative of a vibration at a surface region of target object 10 imaged by the respective pixel element 30.

In the example of FIG. 5, computation engine 40 assigns different colors to different amplitude values of filtered signals 35. For example, a color (e.g., a chroma value) of a pixel in output representation 500 corresponds to an amplitude of the vibration at a surface of target object 10 that corresponds to at least one frequency of reference signal 25. For example, for a filtered signal 35 indicative of a high amplitude of vibration at a surface of target object 10 that corresponds to the at least one frequency of reference signal 25, computation engine 40 may render a corresponding pixel of output representation 500 as “white.” As another example, for a filtered signal 35 indicative of a medium-high, medium, or medium-low amplitude of vibration at a surface of target object 10 that corresponds to the at least one frequency of reference signal 25, computation engine 40 may render a corresponding pixel of output representation 500 as “red,” “yellow,” or “green,” respectively, depending on the particular amplitude of vibration at the surface of target object 10 corresponding to the at least one frequency of reference signal 25. Further, for a filtered signal 35 indicative of minimum or no vibration at the surface of target object 10, computation engine 40 may render a corresponding pixel of output representation 500 as “blue” or “black,” respectively. The aforementioned colors and categories are provided as examples only and are not intended to be limiting. The techniques of the disclosure contemplate the use of these colors or other colors not expressly described herein, which may be assigned to various different amplitudes of vibration of more or fewer categories, according to the particular implementation for which they are used.

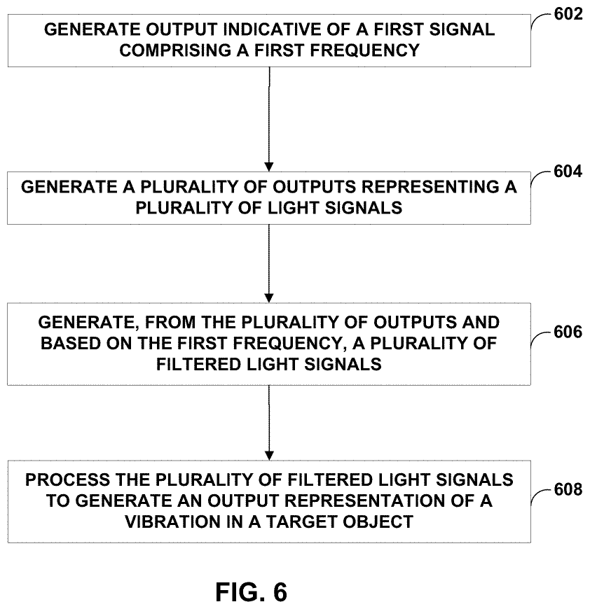

FIG. 6 is a flowchart illustrating an example operation for detecting vibration of a target object using light signals in accordance with the techniques of the disclosure. For convenience, FIG. 6 is described with respect to FIGS. 1 and 2.

Sensor 20 generates output 25 indicative of a first signal 15 detected by sensor 20 (602). The first signal 15 comprises a first set of one or more frequencies. The first signal 15 may be indicative of an acoustic or physical vibration 15 in an environment. Typically, the set of one or more frequencies comprises a frequency of interest to a user. The first signal 15 may correlate to the vibration in target object 10. For example, where target object 10 is a motor, first signal 15 may be an audible noise that correlates to an unusual vibration in target object 10. In some examples, sensor 20 is a microphone, accelerometer, electromagnetic sensor, or pressure sensor. In another example, sensor 20 senses an electrocardiogram (ECG) or photoplethysmogram of a patient.

Each light amplitude detector 210 of a plurality of pixel elements 30 of optical array 60 generates an electrical output 215 of a plurality of electrical outputs 215 (604). Each output 215 is indicative of a luma component of reflected light λ′ received by a respective light amplitude detector 210 from a region of target object 10. Further, each pixel element 30 generates, from the plurality of electrical outputs 215 and based on first signal 15, a plurality of filtered light signals 35 (606). For example, each analog multiplier 220 of each pixel element 30 of the plurality of pixel elements 30 multiplies a respective electrical output 215 with first signal 15 of sensor 20 to generate a respective output signal 225 of a plurality of output signals 225. Each low-pass filter 230 of each pixel element 30 filters a respective output signal 225 to generate a respective filtered signal 35 of the plurality of filtered signals 35. Each filtered signal 35 relates to a vibration of the region of target object 10 that corresponds to a respective light amplitude detector 215. For example, a frequency of the vibration of the region of the target object 10 corresponding to a respective light amplitude detector 210 is within a frequency band defined by at least one frequency of the first plurality of frequencies of first signal 15 of sensor 20. Each filtered signal 35 has a DC component where a modulation frequency of the luma component of reflected light λ′ due to vibration in target object 10 is the same as a frequency of reference signal 25. Further, each filtered signal 35 has a low frequency component defined by low-pass filter 230 where a modulation frequency of the luma component of reflected light λ′ due to vibration in target object 10 is similar to but not the same as a frequency of reference signal 25. Additionally, each filtered signal 35 has an amplitude corresponding to an amplitude of vibration of target object 10 within a frequency band defined by the at least one frequency of the first plurality of frequencies of first signal 15 of sensor 20.

Computation engine 40 processes filtered signals 35 of each pixel element 30 of optical array 60 to generate output representation 50 of the vibration of target object 10 (608). For example, output representation 50 may be, e.g., an image showing intensity, duration, and location of vibrations in both time series and/or frequency spectra of target object 10. Therefore, it may be recognized that output representation 50 is a representation of vibration in target object 10 at a frequency corresponding to at least one frequency detected by sensor 20 or approximating the at least one frequency detected by sensor 20. Output representation 50 may be used to rapidly visualize and identify the source (e.g., target object 10) of a vibration at a frequency corresponding to at least one frequency detected by sensor 20 within an environment.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples have been described. These and other examples are within the scope of the following claims.

What is claimed is:

1. A system for detecting a vibration of a target object using light signals, the system comprising:
a sensor configured to generate an output of the sensor, the output of the sensor indicative of a first signal detected by the sensor, wherein the first signal has a first plurality of frequencies;
an array of light amplitude detectors, wherein each respective light amplitude detector in the array of light amplitude detectors is configured to receive a respective light signal from a region of the target object that corresponds to the respective light amplitude detector and to generate an output of the respective light amplitude detector, the output of the respective light amplitude detector representing the light signal received by the respective light amplitude detector from the region of the target object that corresponds to the respective light amplitude detector, wherein the sensor is external to the array of light amplitude detectors;
a plurality of filters, wherein each filter of the plurality of filters is operatively coupled to a respective light amplitude detector of the array of light amplitude detectors and each filter of the plurality of filters is operatively coupled to the sensor, and
wherein each respective filter of the plurality of filters is configured to:
receive, from the light amplitude detector of the array of light amplitude detectors operatively coupled to the respective filter, the output of the respective light amplitude detector; and
generate, from the output of the respective light amplitude detector and based on the first plurality of frequencies of the first signal, a filtered signal of the respective filter, wherein the filtered signal of the respective filter relates to a vibration of the region of the target object that corresponds to the respective light amplitude detector, and wherein a frequency of the vibration of the region of the target object that corresponds to the respective light amplitude detector is within a frequency band defined by at least one frequency of the first plurality of frequencies; and
processing circuitry configured to process the filtered signals of the plurality of filters to generate an output representation of the vibration of the target object.

2. The system of claim 1, wherein the output representation of the vibration of the target object is an image that represents the vibration of the target object.

3. The system of claim 2, wherein the image comprises an array of pixels, each pixel of the array of pixels corresponding to a respective light amplitude detector of the array of light amplitude detectors, and wherein a characteristic of each pixel of the array of pixels is associated with an amplitude of the vibration of the corresponding region of the target object.

4. The system of claim 3, wherein, for each pixel of the array of pixels, the characteristic of the pixel is a luma component of the pixel, and a value of the luma component of pixel of the array of pixels is associated with the amplitude of the vibration of the corresponding region of the target object.

5. The system of claim 3, wherein, for each pixel of the array of pixels, the characteristic of the pixel is color, and a color of the pixel is associated with the amplitude of the vibration of the corresponding region of the target object.

6. The system of claim 1, wherein the sensor is a microphone and the first signal comprises an audio signal detected by the microphone.

7. The system of claim 1, wherein the sensor is an accelerometer and the first signal comprises a mechanical vibration detected by the accelerometer.

8. The system of claim 1, wherein the sensor is an electromagnetic sensor and the first signal comprises an electromagnetic signal detected by the electromagnetic sensor.

9. The system of claim 1, wherein each respective light amplitude detector in the array of light amplitude detectors is a respective analog light amplitude detector and the output of the respective light amplitude detector is a respective analog output representing the light signal received by the respective analog light amplitude detector from the region of the target object that corresponds to the respective analog light amplitude detector.

10. The system of claim 1, wherein each filter of the plurality of filters comprises an adjustable band-pass filter centered on the at least one frequency of the first plurality of frequencies of the first signal.

11. The system of claim 1, wherein each filter of the plurality of filters comprises at least one mixer configured to mix the output of the respective light amplitude detector with the first signal.

12. The system of claim 11, wherein the at least one mixer comprises a multiplier.

13. A method for detecting a vibration of a target object using light signals, the method comprising:
generating, by a sensor, an output of the sensor, the output of the sensor indicative of a first signal detected by the sensor, wherein the first signal has a first plurality of frequencies;
generating, by each respective light amplitude detector in an array of light amplitude detectors, an output of the light amplitude detector, the output of the respective light amplitude detector representing a light signal received by the respective light amplitude detector from a region of the target object that corresponds to the respective light amplitude detector, wherein the sensor is external to the array of light amplitude detectors;
receiving, by each respective filter of a plurality of filters and from a respective light amplitude detector of the array of light amplitude detectors operatively coupled to the respective filter, the output of the respective light amplitude detector; and
generating, by each respective filter of the plurality of filters, from the output of the respective light amplitude detector, and based on the first plurality of frequencies of the first signal, a filtered signal of the respective filter, wherein the filtered signal of the respective filter relates to a vibration of the region of the target object that corresponds to the respective light amplitude detector, wherein a frequency of the vibration of the region of the target object that corresponds to the respective light amplitude detector is within a frequency band defined by at least one frequency of the first plurality of frequencies; and
processing, by processing circuitry, the filtered signals of the plurality of filters to generate an output representation of the vibration of the target object.

14. The method of claim 13, wherein the output representation of the vibration of the target object is an image that represents the vibration of the target object.

15. The method of claim 14, wherein the image comprises an array of pixels, each pixel of the array of pixels corresponding to a respective light amplitude detector of the array of light amplitude detectors, and wherein a characteristic of each pixel of the array of pixels is associated with an amplitude of the vibration of the corresponding region of the target object.

16. The method of claim 15, wherein, for each pixel of the array of pixels, the characteristic of the pixel is a luma component of the pixel, and a value of the luma component of pixel of the array of pixels is associated with the amplitude of the vibration of the corresponding region of the target object.

17. The method of claim 15, wherein, for each pixel of the array of pixels, the characteristic of the pixel is color, and a color of the pixel is associated with the amplitude of the vibration of the corresponding region of the target object.

18. The method of claim 13, wherein the sensor is a microphone and the first signal is indicative of an audio signal detected by the microphone.

19. The method of claim 13, wherein the sensor is an accelerometer and the first signal is indicative of a mechanical vibration detected by the accelerometer.

20. The method of claim 13, wherein the sensor is a electromagnetic sensor and the first signal is indicative of an electromagnetic signal detected by the electromagnetic sensor.

21. The method of claim 13, wherein each filter of the plurality of filters comprises an adjustable band-pass filter centered on the at least one frequency of the first plurality of frequencies of the first signal.

22. A device for detecting a vibration of a target object using light signals, the device comprising:
a sensor configured to generate an output of the sensor, the output of the sensor indicative of a first signal detected by the sensor, wherein the first signal has a first plurality of frequencies;
an array of light amplitude detectors, wherein each respective light amplitude detector in the array of light amplitude detectors is configured to receive a respective light signal from a region of the target object that corresponds to the respective light amplitude detector and to generate an output of the respective light amplitude detector, the output of the respective light amplitude detector representing the light signal received by the respective light amplitude detector from the region of the target object that corresponds to the respective light amplitude detector, wherein the sensor is external to the array of light amplitude detectors;
a plurality of filters, wherein each filter of the plurality of filters is operatively coupled to a respective light amplitude detector of the array of light amplitude detectors and each filter of the plurality of filters is operatively coupled to the sensor, and
wherein each respective filter of the plurality of filters is configured to:
receive, from the light amplitude detector of the array of light amplitude detectors operatively coupled to the respective filter, the output of the respective light amplitude detector; and
generate, from the output of the respective light amplitude detector and based on the first plurality of frequencies of the first signal, a filtered signal of the respective filter, wherein the filtered signal of the respective filter relates to a vibration of the region of the target object that corresponds to the respective light amplitude detector, and wherein a frequency of the vibration of the region of the target object that corresponds to the respective light amplitude detector is within a frequency band defined by at least one frequency of the first plurality of frequencies; and
processing circuitry configured to process the filtered signals of the plurality of filters to generate an output representation of the vibration of the target object.
